(19) United States
(12) Patent Application Publication
(10) Pub. No.: US 2005/0063182 A1
(43) Pub. Date: Mar. 24, 2005

(54) Method and apparatus for light emitting diode traffic signal

(75) Inventors: John Francis Birch, Austin, TX (US); David Dodd Miller, Austin, TX (US)

Correspondence Address: Elsa Keller;Siemens Corporation, Intellectual Property Department, 170 Wood Avenue South, Iselin, NJ, 08830, US

(73) Assignee: Siemens Energy & Automation, Inc.

(21) Appl. No.: 10/668,948

(22) Filed: Sep. 23, 2003

(51) Int. Cl. F21V 21/00

(52) U.S. Cl. 362/249

(57) ABSTRACT

A light emitting diode traffic signal apparatus and method used for shaping and directing a desired beam path of light. The apparatus orients a plurality of LED lamps using a mounting surface assembly coupled to a traffic signal head. The method includes orienting the plurality of LED lamps by mounting LED lamps to a surface assembly within the traffic signal head. The surface assembly is oriented using predetermined calculations.

### FIELD OF INVENTION

The present invention relates to traffic signal light emitting diode (LED) lamp assemblies, and more particularly, it pertains to an apparatus and method of controlling the pattern of light and output of light emitted from a light emitting diode lamp assembly.

### BACKGROUND OF INVENTION

At the present time, traffic light signals are illuminated using two different light sources: incandescent lamps and LED lamps. In traffic light signals having incandescent lamps, each individual section is lighted by an incandescent light bulb with a tungsten filament where a section is an individual lighted portion, such as the red, yellow, green, or arrow section of a traffic light. Because the light bulb and filament project light in all directions, a reflector is added behind the bulb. This reflector is parabolic-shaped to direct the light towards the front of the traffic light signal. Because the incandescent bulb creates the characteristic orange and white tungsten color, each desired color such as red, green or yellow must be achieved via a colored lens installed in front of the bulb. Each colored lens filters out most of the light, except the wavelength of the desired color. For example, the red section of the traffic light signal is covered with a red lens that blocks all of the visible spectrum of light colors except red. This lens is usually used to further focus and direct the light downward to the street level.

In traffic light signals with LED lamps, each individual section is lighted by a number of LED lamps made up of silicon that is “doped”: a special chemical mixture used to produce a desired color light. Because the actual LED silicon chip is flat, most of the light is directed forward on a narrow axis, minimizing the need for a reflector. Also, because the doping results in light of the desired color, no colored filter is required, and no light of other colors is blocked out. Because the light is projected from the tiny silicon chip on a very narrow axis, the LED chip is usually packaged in a clear plastic case that includes a convex lens shape. This shape broadens the axis to allow the LED to be visible from a wider viewing angle.

There are disadvantages associated with the use of conventional incandescent traffic light signals. The life span of an incandescent lamp is short and varies due to vibration and temperature extremes causing light bulbs to be replaced often. Similarly, incandescent lamps become extremely hot resulting in power consumption by the lamp which generates heat as opposed to light. Additionally, expensive materials must be used within the traffic light signal embodiment to withstand the high temperatures. A large amount of power is also used to block out all the unnecessary frequencies not used in the light as opposed to generating light. Because incandescent lamps require reflectors, strong light sources such as a rising or setting sun, will be reflected causing confusion in reading the traffic light signal. Lastly, because a lens is used to produce the desired light pattern, the lens simultaneously creates inefficiencies by reflecting and scattering a portion of the light.

There are also disadvantages associated with the use of a conventional LED traffic light signals. The convex case of each LED lamp produces a controlled but inappropriate light pattern. Lenses using more LED lamps are used to solve this difficulty. However, the imperfect lens blocks and scatters portions of the light. Also, more LED lamps are used than necessary. While a large portion of the LED lamp light goes in the desired direction, the remaining light is wasted.

Therefore, the need exists to produce a simple and efficient traffic light signal that aims to overcome and mitigate at least one of the foregoing disadvantages.

### SUMMARY OF INVENTION

The present invention relates to providing a light emitting diode traffic signal apparatus and method which produces a desired light pattern and desired output of light. This can be achieved by orienting a plurality of LED lamps within the traffic signal head apparatus to produce the desired light pattern and output of light.

It is an object of the present invention to provide a properly designed LED vehicle traffic signal head that is free of secondary lenses or other secondary optics.

It is also an object of the present invention to provide a LED vehicle traffic signal head with the simplest construction.

It is an object of the present invention to provide a LED vehicle traffic signal head with minimal loss of light and heat.

It is another object of the present invention to provide a properly designed LED vehicle traffic signal head with the capability of increasing the life span of the LED vehicle traffic signal head.

It is a further object of the present invention to be able to use an unlimited number of different patterns and colors generated by one traffic signal head.

It is another object of the present invention to be able to generate two or more different patterns of light of one color by one traffic signal head.

The present invention can be achieved by fulfilling one or more of the above objects, alone or in combination.

In accordance with one aspect of this invention, a light head for a traffic signal housing, comprising a plurality of LED lamps affixed to and projecting from substrate inclined therein conductive pathways formed thereon for supplying power thereto, and the plurality of LED lamps may be selectively oriented on the substrate at least during fabrication thereof, so as to shape output light beam.

In accordance with another aspect of this invention, a traffic signal head comprises a mounting structure for coupling the traffic signal head; and a plurality of LED lamps selectively oriented obliquely in the mounting structure so that respective projected outputs thereof are combined and shaped to form a selected pattern including at least one of desired intensity and direction.

In accordance with another aspect of this invention, a method of shaping a desired beam path of light, method comprising coupling a mounting assembly to a signal housing, orienting a plurality of LED lamps coupled to the mounting assembly within the signal housing, and transmitting a signal from the signal housing to a street using a traffic signal device.

In accordance with another aspect of this invention, a mounting plate assembly for a light head of a traffic signal housing, comprises at least one printed circuit board, at least one wing plate, and at least one vertical plate coupled to a signal housing.

### BRIEF DESCRIPTION OF DRAWINGS

FIG. 1 is a perspective view of a traffic signal head.

FIG. 2 is a perspective view of a light emitting diode.

FIG. 3 is a side view of a light emitting diode.

FIG. 4 is a perspective view of a plurality of LED lamps mounted on a circuit board.

FIG. 5a is a front view of the vertical plate.

FIG. 5b is rear view of the back surface of the signal head.

FIG. 5c is a perspective view of a plurality of LED lamps mounted on a circuit board where the circuit board is mounted to the back surface of the traffic signal head.

FIG. 6 is a front elevation view of the traffic signal head.

FIG. 7 is a side view of the signal head.

FIG. 8 is a top plan view of the traffic signal head perpendicular to the plane of the printed circuit board.

FIG. 9 is a perspective view of a plurality of LED lamps mounted on a circuit board where the circuit board is mounted on the back surface of the signal head and a light pattern extended from the LED lamps.

FIG. 10 is a side elevational view of the traffic signal head mounted atop a traffic light pole.

FIG. 11a is a bottom edge view LED lamps mounted on a trifold assembly.

FIG. 11b is a perspective view of a center board coupled to two wingplates.

FIG. 12 is the projection of light grid as by the light sensor.

FIG. 13a is an overhead view of a light pattern for a high speed vehicle with no turns.

FIG. 13b is a side view of a light pattern with no turns for a high speed vehicle.

FIG. 13c is a side view of a light pattern with a preferred vehicle distance of 205 feet (62.5 m) from the traffic signal.

FIG. 13d is an overhead view of a light pattern for a left turn.

FIG. 13e is a side view of a light pattern for a left turn for a low speed vehicle.

FIG. 13f is a side view of a light pattern at a preferred vehicle distance of 68 feett (20.7 m) from the traffic signal.

FIG. 14 is an cross section of an LED embedded in a substrate.

### DETAILED DESCRIPTION OF THE PREFERRED EMBODIMENTS

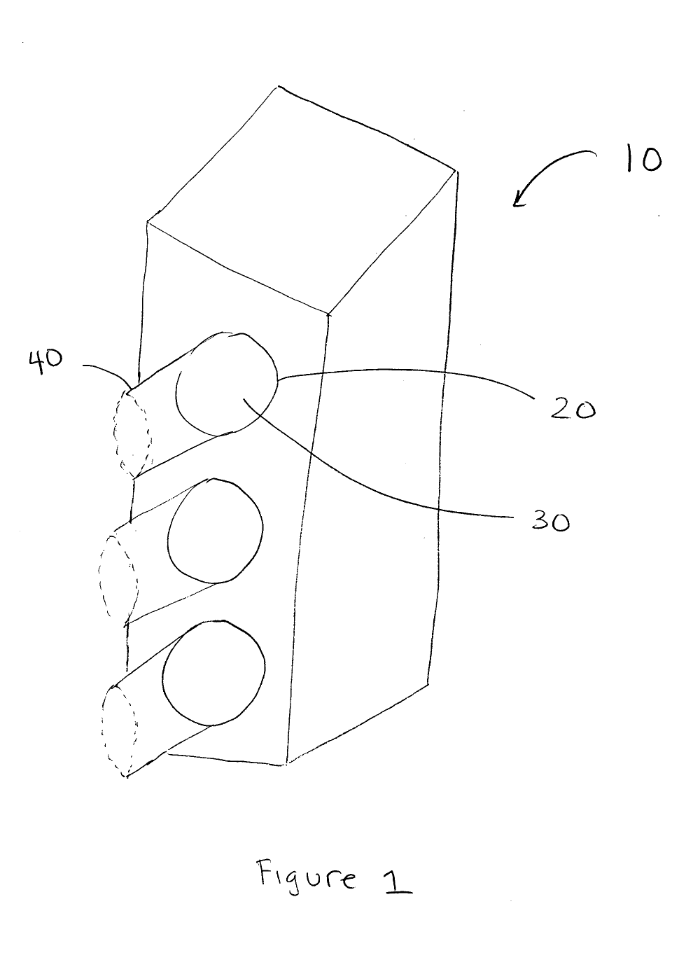

FIGS. 1-14 disclose an apparatus and method used to shape an output beam path of the LED lamp array without the use of a lens. Desirably, the lamp array can be utilized in a traffic signal light selection.

FIG. 1 shows a traffic signal head 10 comprising lens 20 with clear cover 30 to protect the lens 20 from natural elements. A visor 40 prevents the light radiating from the traffic signal head 10 to be visible to cross traffic at a road intersection.

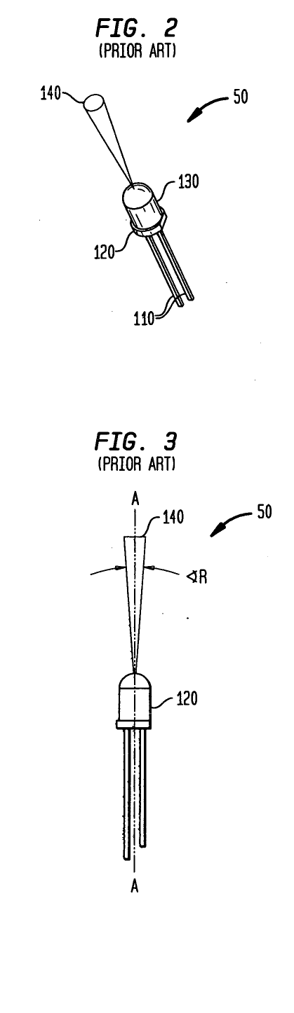

FIG. 2 illustrates a typical LED lamp 50 that is used as a component of the traffic signal head 10 of the present invention. Electric current flows through the LED lamp 50 via the two conductive leads 110. After current is directed to the conductive leads 110, the LED lamp 50 illuminates. The plastic body 120 of the LED lamp 50 is constructed of clear plastic and encapsulates a silicon chip 130 that emits light. The top of the plastic body 120 is a convex shape that spreads the small shaft of light into a cone shaped light pattern 140.

FIG. 3 shows a side view of the plastic body 120 and the cone shaped light pattern 140. The convex surface of the plastic body 120 creates an angle R, preferably an 8° pattern, respective to longitudinal axis A-A which runs along the central axis of LED lamp 50. The size of angle R is dependent on the particular LED lamp 50 used and may span between 6 and 30°, with a preferable angle measurement of 8°. One skilled in the art may select any structure of LED lamp 50 in order to practice the present invention.

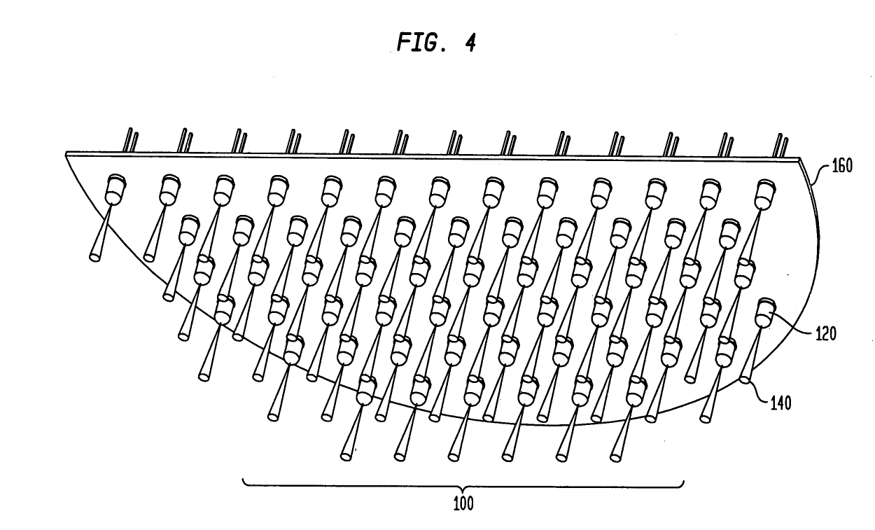

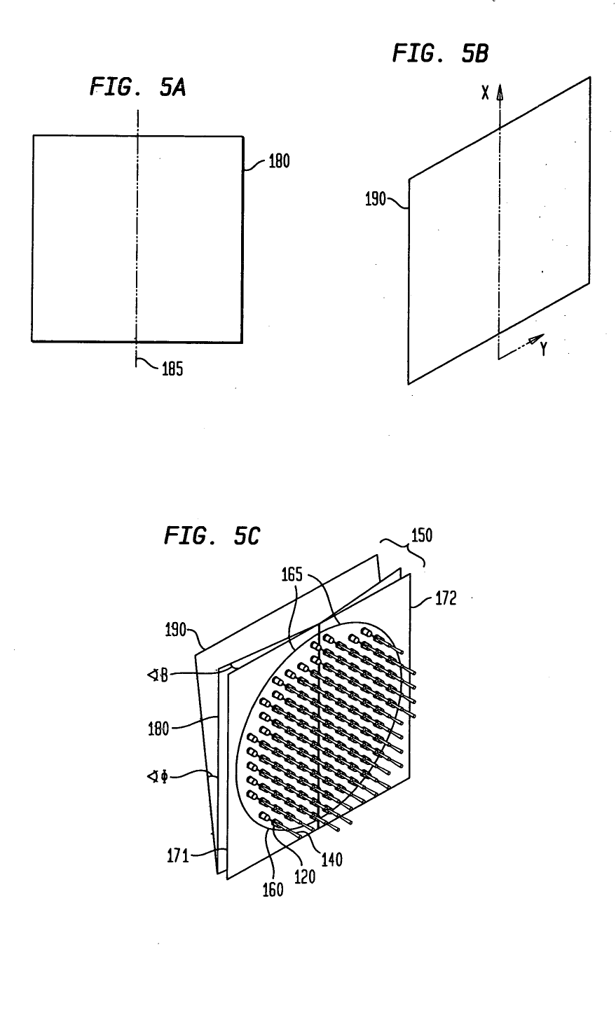

FIGS. 4 and 5c refer to a plurality of LED lamps 100 from FIGS. 1 and 2, mounted on surface assembly 150 comprising printed circuit board 160, wing plate 170, and vertical plate 180. The plurality of LED lamps 100 are arrayed generally perpendicular to the substantially planar surface of the printed circuit board 160 in equidistant vertical and horizontal rows. Printed circuit board 160 is shaped as a semi circle. Others skilled in the art may select varying shapes for a printed circuit board 160 depending on their specifications, including a circle, square, rectangle, or trapezoid. The printed circuit board 160 includes a substantially planar surface composed of a fiber glass material. While the previously described embodiment shows application of a non-flexible material used to compose the printed circuit board, others skilled in the art may choose a flexible material to manufacture the printed circuit board. The plurality of LED lamps 100 are depicted emitting a cone shaped light pattern 140 that is 1 inch long (2.5 cm), where the light patterns 140 will overlap each other at a distance greater than 1 inch (2.5 cm). The plurality of LED lamps 100 are electrically wired in parallel to maintain operability in case of failure of one LED lamp 50.

FIGS. 5a-c depicts two semi circular shaped printed circuit boards 160 that form printed circuit board assembly 165 where plastic body 120, cone shaped light pattern 140, and printed circuit board assembly 165 are mounted to the back surface of a traffic signal head 190 to form a traffic signal head 10. The printed circuit board assembly 165 is aimed generally downwards via vertical plate 180 and is aimed generally inboard via wing plate 170. Printed circuit board assembly 165 is affixed to wing plate 170. Others skilled in the art may define affixation as methods of welding, glueing, fastenening or stapling. Wing plate 170 is positioned inboard from the vertical center line 185 of vertical plate 180 by angle β, also described as the horizontal angle left and right, having a range of 3.5° or greater. Vertical plate 180 is aimed generally downwards from the back surface of traffic signal head 190 by angle θ, also described as the vertical angle down. Angle Φ ranges between 1-5°. Angle θ preferably should be greater than angle Φ. It is important to note that the angles mentioned above depend on the specific LED lamp 50 used.

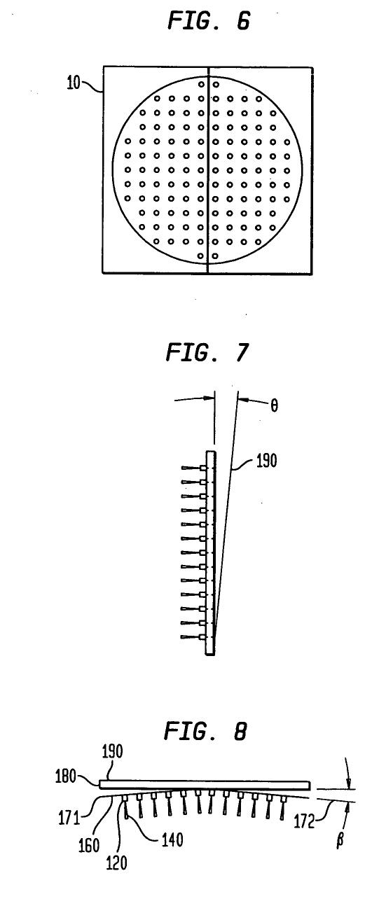

FIG. 6 refers to a front view of the traffic signal head 10, as it would be viewed by an oncoming vehicle 200.

FIG. 7 depicts a side view of the traffic signal head 10 where the back surface of traffic signal head 190 is the vertical mounting point of reference. If the back surface of traffic signal head 190 is mounted vertically, the plurality of LED lamps 100 will be preferably aimed downward at an angle θ of 4.6° from the back surface of the traffic signal head 190.

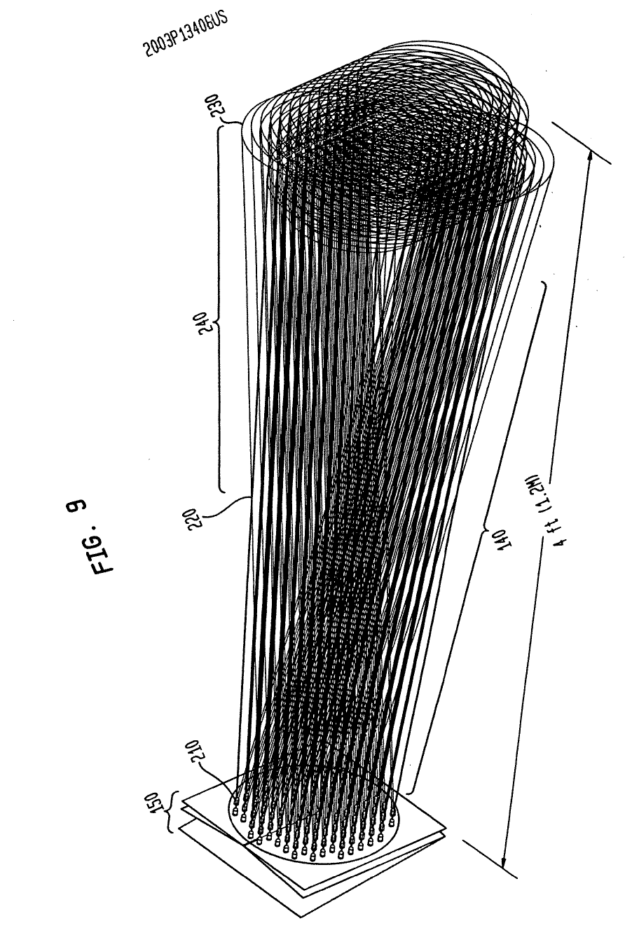

FIG. 8 shows a top view of the traffic signal head 10 generally perpendicular to the plane of the printed circuit board 160. A first and second wing plates 171, 172 cause each of the two printed circuit board assemblies 160 to be aimed inward at a β angle of 3.5°. This structural arrangement causes the plurality of LED lamps 100 to be angled both horizontally and vertically creating the desired light pattern without the use of a lens. Also it is important to note that all of the plurality of LED lamps 100 are still depicted emitting 1 inch (2.5 cm) cone shaped light pattern 140.

FIG. 9 refers to a traffic signal head 10 mounted identically per FIGS. 4-8 but with the aggregate cone shaped light pattern 140 extended to 4 feet (1.2 m) in length. Note that the portion of the aggregate cone shaped light pattern 140 between the beginning point 210 of cone shaped light pattern 140 and midpoint 220 of the cone shaped light pattern 140 extends in a generally straight line without conical dispersion. This is due to the fact that the two printed circuit board assemblies 160 are aimed inboard at an angle β of 3.5°, and the cone shaped light patterns 140 actually cross each other. This allows the installation of a visor 30 or tube (see FIG. 1) to prevent light radiating from the traffic signal head 10 to be visible to cross traffic at a road intersection. The portion of the cone shaped light pattern 140 after the patterns cross between midpoint 220 of the cone shaped light pattern 140 and endpoint 230 of cone shaped pattern 140 creates a new secondary aggregate cone shaped light pattern 240 that spreads out normally in a gradual and even way. The new secondary aggregate cone shaped light pattern 240 is shaped and oriented so as to have a non parallel or oblique output beam path using an intentionally converging and diverging point.

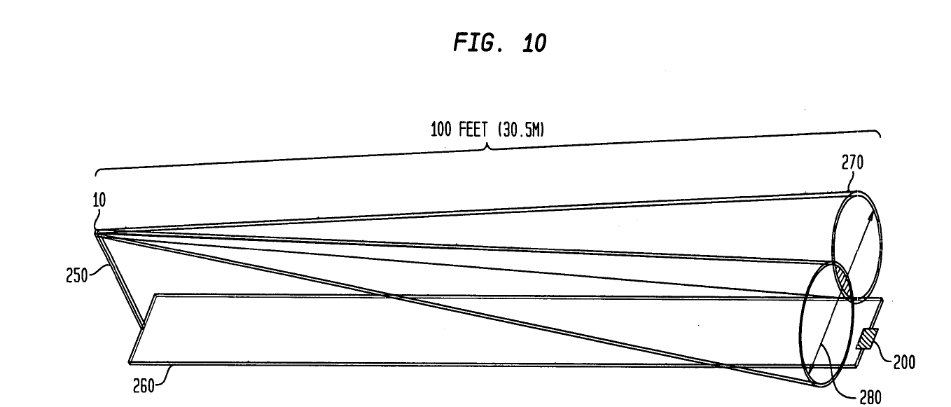

FIG. 10 refers to the traffic signal head 10 mounted atop a 15 feet (4.6 m) pole 250. A typical 12 feet (3.7 m) wide vehicle lane 280 is depicted with the cone shaped light pattern 140 extended to 100 feet (30.5 m) at endpoint 270. Note that a vehicle 200 approaching the traffic signal head 10 will encounter a normal, highly visible traffic signal, as the cone shaped light pattern 140 now extends downward to the street level and across two vehicle lanes 280. Note, also that this desired result was obtained by controlling the cone shaped light pattern 140 without the use of a lens.

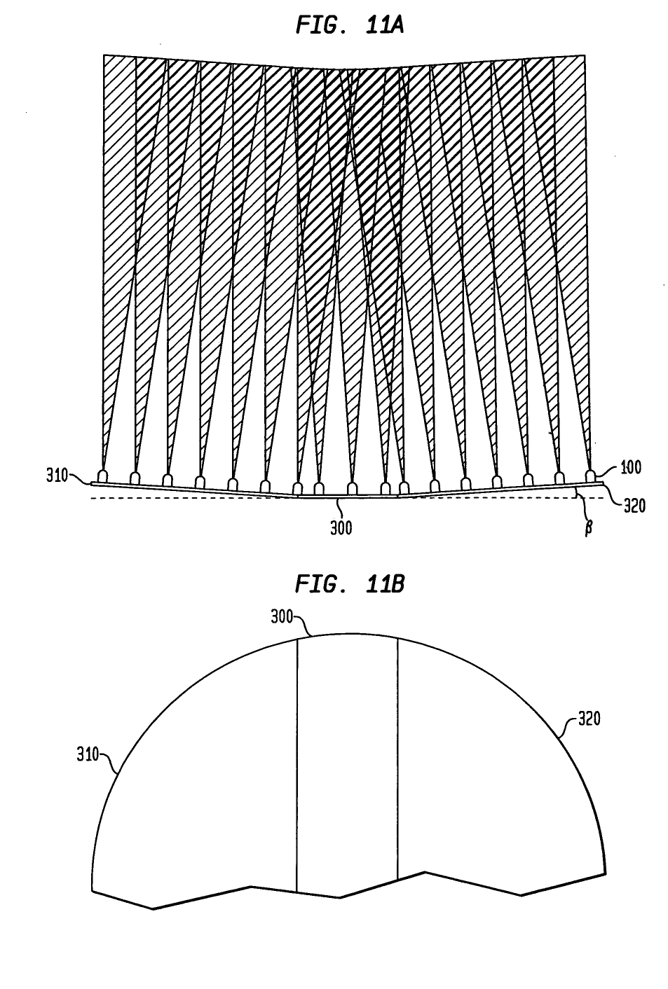

FIGS. 11a and 11b show an alternative embodiment using a three piece assembly to mount the plurality of LED lamps 100. The center circuit board 300 is aimed at the center of viewing range. The first and second wing plates 310, 320 are determined by the width and location of the target area. This embodiment is intended to satisfy the requirements for light distribution patterns requiring a wide viewing area however need much more intense light in the center than elsewhere.

The light output of traffic signal head 10 is specified by the Institute of Transportation Engineers (ITE) in Table 1 of the ITE Standard for Vehicle Traffic Control Signal Heads:

TABLE 1
Minimum Laboratory Intensity Requirements of Colored Lenses

| Test Point | | | | | | | |
|---|---|---|---|---|---|---|---|
| | Horiz. | | | | | | |
| Vertical | Angle | Candlepower Values (candelas) | | | | | |
| Angle | Left & | 8-inch Signal | | | 12-inch Signal | | |
| Down | Right | Red | Yellow | Green | Red | Yellow | Green |
| 2.5° | 2.5° | 157 | 726 | 314 | 399 | 1848 | 798 |
| | 7.5° | 114 | 528 | 228 | 295 | 1364 | 589 |
| | 12.5° | 67 | 308 | 133 | 166 | 770 | 333 |
| | 17.5° | 29 | 132 | 57 | 90 | 418 | 181 |
| 7.5° | 2.5° | 119 | 550 | 238 | 266 | 1232 | 533 |
| | 7.5° | 105 | 484 | 209 | 238 | 1100 | 475 |
| | 12.5° | 76 | 352 | 152 | 171 | 792 | 342 |
| | 17.5° | 48 | 220 | 95 | 105 | 484 | 209 |
| | 22.5° | 21 | 99 | 43 | 45 | 209 | 90 |
| | 27.5° | 12 | 55 | 24 | 19 | 88 | 38 |
| 12.5° | 2.5° | 43 | 198 | 85 | 59 | 275 | 119 |
| | 7.5° | 38 | 176 | 76 | 57 | 264 | 114 |
| | 12.5° | 33 | 154 | 67 | 52 | 242 | 105 |
| | 17.5° | 24 | 110 | 48 | 40 | 187 | 81 |
| | 22.5° | 14 | 66 | 29 | 26 | 121 | 52 |
| | 27.5° | 10 | 44 | 19 | 19 | 88 | 38 |
| 17.5° | 2.5° | 19 | 88 | 38 | 26 | 121 | 52 |
| | 7.5° | 17 | 77 | 33 | 26 | 121 | 52 |
| | 12.5° | 12 | 55 | 24 | 26 | 121 | 52 |
| | 17.5° | 10 | 44 | 19 | 26 | 121 | 52 |
| | 22.5° | 7 | 33 | 14 | 24 | 110 | 48 |
| | 27.5° | 5 | 22 | 10 | 19 | 88 | 38 |

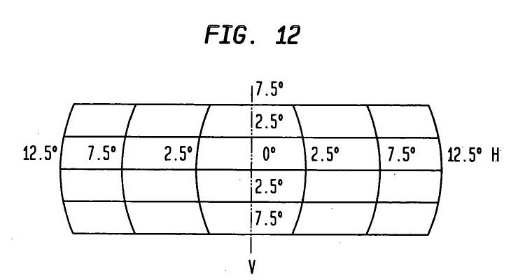

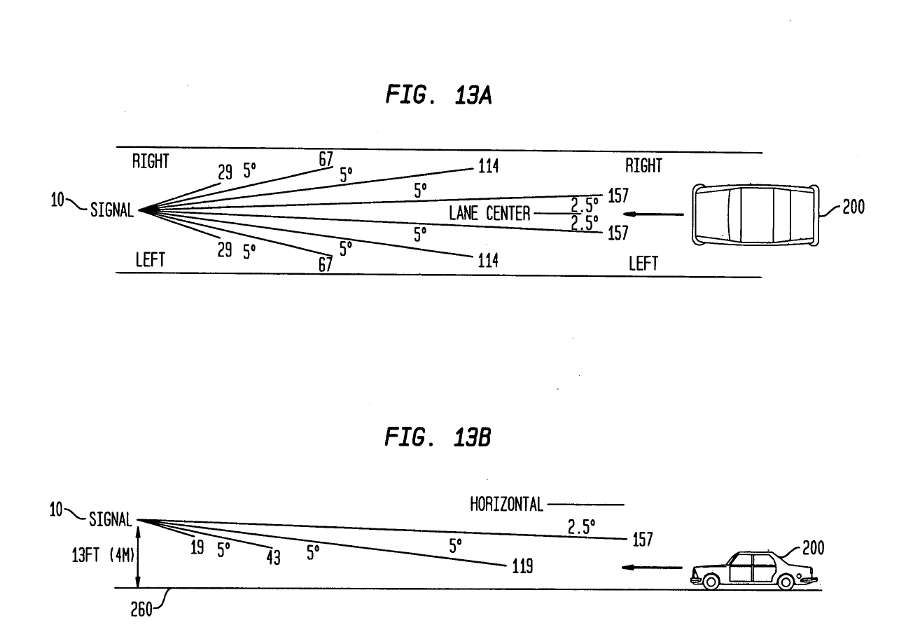

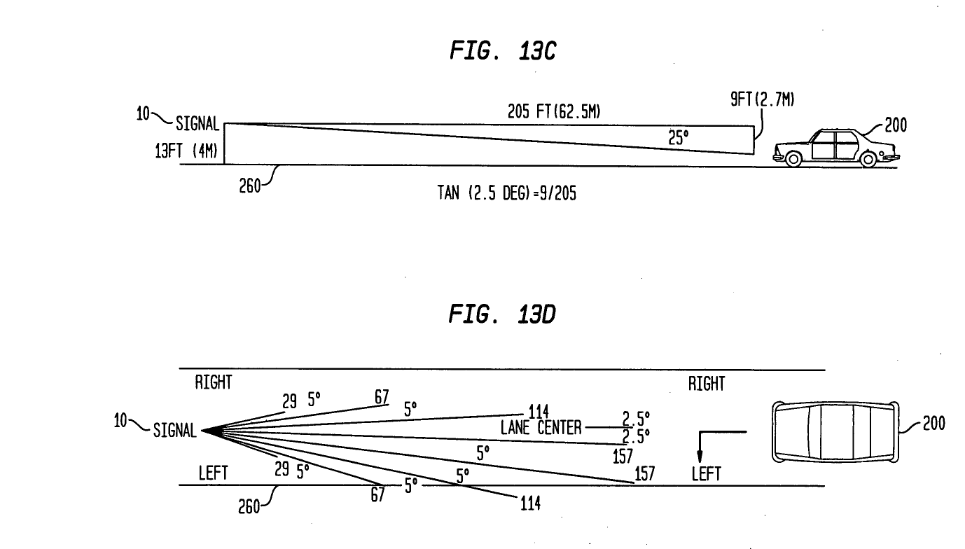

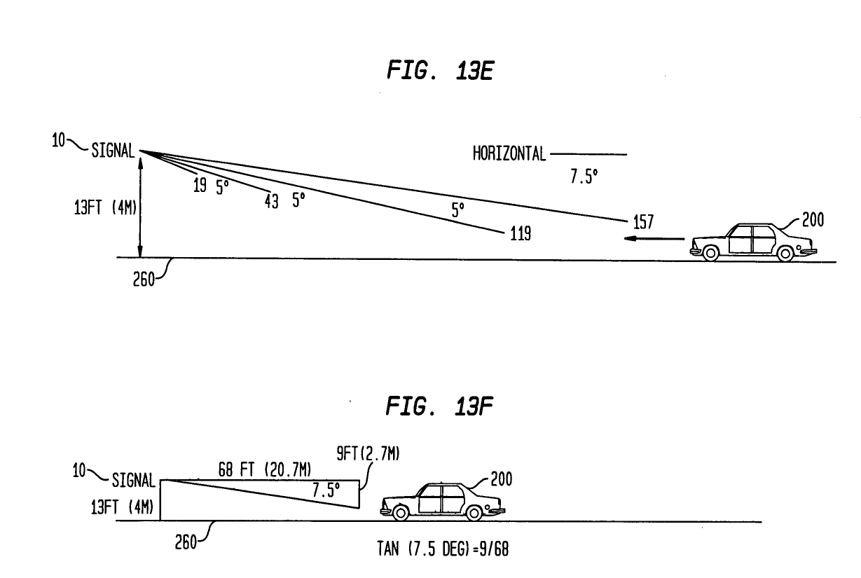

As can be seen from Table 1 and FIG. 12, the light pattern 140 from the traffic signal head 10 is dispersed slightly downward from horizontal, and across the center of the vehicle lane 260. Dispersion pattern and the method to control the dispersion pattern without secondary optics is shown in FIGS. 1-11. FIGS. 12 and 13a show the light dispersion pattern 140 of the plurality of LED lamps 100 in the case of the 8 inches (20 cm) red signal, measured at a Φ angle of 2.5° down from horizontal. The light intensity in candelas is shown by lines with a length proportional to intensity. To attain the proper intensity at the proper angle, the plurality of LED lamps 100 are described in FIGS. 1-11 above. For example, twenty LED lamps 50, each with an intensity of 8 candela and a 5° cone could be used to achieve 157 candelas over an angle ranging from angle β of 2.5° left of lane center, to angle β of 2.5° right of lane center. The remaining dispersion of 114 candelas at angle β of 7.5°, 67 candelas at angle Φ of 12.5°, and 29 candelas at angle β of 17.5°.

Referring to FIG. 13b, the traffic signal head 10 is placed 13 feet (4.0 m) above the vehicle lane 260. From Table 1, the light pattern shown is 157 candelas at an angle Φ of 2.5° down angle, 119 candelas at an angle Φ of 7.5° down, 43 candelas at an Φ of 12.5° down, and 19 candelas at an angle E of 17.5° down. By continuing to fill in all 22 of the candela intensities shown in the “8 inches (20 cm) Signal Red” column of Table 1, the 3-dimensional light pattern 140 shown in FIG. 10 is realized.

FIG. 13c shows a preferred light pattern distance. The light pattern intensity is the greatest at a down Φ angle of 2.5° and an angle β of 2.5° left and right of the centerline of vehicle lane 260. With the traffic signal head 10 mounted 13 feet (4.0 m) above the vehicle lane 260, and the driver situated 4 feet (1.2 m) above the vehicle lane 260, the light intensity is 157 candelas at a distance of 205 feet (62.5 m) from the traffic signal head 10. This distance can be calculated using the formula:
TAN(A)=(S−H)/D
where TAN is the trigonometric tangent, A is the down angle Φ, S is the traffic signal head 10 height, H is the driver height, and D is the distance from the driver to the vehicle lane 260 below the traffic signal head 10. Note that the trigonometric tangent can also be used to calculate the horizontal light dispersion. For example, at a distance of 205 feet (62.5 m), 157 candelas is dispersed over a range of 2.5 feet (80 cm) left and right of the center of vehicle lane 260. Using the trigonometric tangent, this calculates to 9 feet to the left and right of center of vehicle lane 260 at 205 feet (62.5 m), insuring coverage of vehicle lanes 260 up to 18 feet (5.5 m) wide. This light pattern may also be used to signal higher speed vehicles 200 proceeding straight through an intersection.

FIGS. 13d-13f describes a preferred light pattern for a left-turn lane. In FIGS. 13d-13e, the plurality of LED lamps 100 are directed an additional angle β of 5° left and an additional angle Φ of 5° downward. The light is directed more towards the left to avoid confusion for drivers in an adjacent through vehicle lane 260.

FIG. 13e shows the light intensity matching the light pattern in FIGS. 13a-13c. FIG. 13e also shows that entire light pattern is directed an additional angle Φ of 5° downward. By adjusting all 22 of the Table 1 intensities by angle Φ of 5° down and angle β of 5° left, the 3-dimensional light pattern shown in FIG. 10 is realized for a left-turn lane.

FIG. 13f describes another light pattern distance. Using the trigonometric tangent formula described above, the 5° downward adjustment of this light pattern decreases the optimal distance from 205 feet (62.5 m) to just 68 feet (20.7 m). Therefore, this light pattern would be less likely to distract distant vehicles in adjacent vehicle lanes 260 than would a light pattern shown in FIGS. 13a-13c, but would still cover several vehicles 200 in a left-turn pocket.

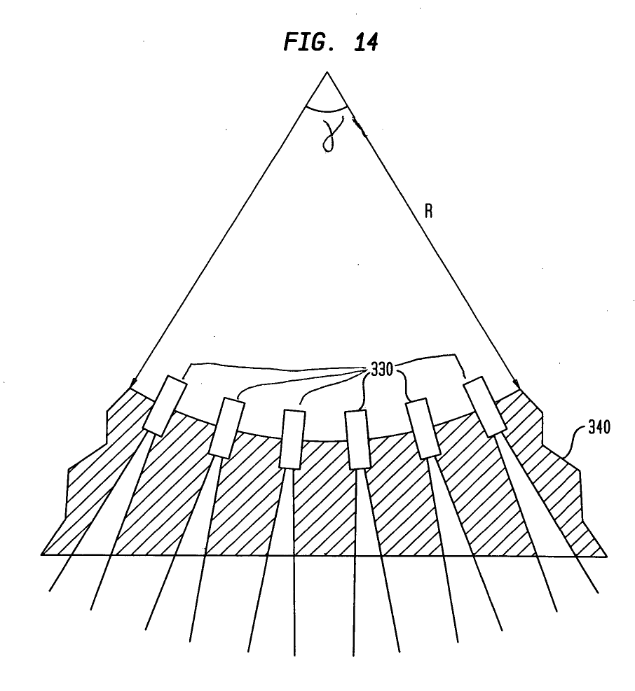

FIG. 14 refers to an alternative embodiment where a plurality of LED lamps 330 are embedded in a substrate 340, rather than a printed circuit board as described earlier. The shape of the substrate 340 may be desired based on angle γ and radius R so as to focus the desired light pattern. Substrate 340 may comprise a cold resin formation or a hot resin formation such as a hot encapsulation of molten plastic resin or cold encapsulation. One skilled in the art may use full or partial encapsulation.

The present invention has been disclosed with reference to certain preferred embodiments in the field of traffic signals. The present invention also can also be applied to other types of signals and signage to this end. Numerous modifications, alterations, and changes to the described embodiments are possible without departing from the sphere and scope of the claims of the present invention. Accordingly, it is intended that the present invention not be limited to the described embodiments and equivalents thereof.

1. A light head for a traffic signal housing, comprising:
a plurality of LED lamps affixed to and projecting from substrate inclined therein conductive pathways formed thereon for supplying power thereto; and
the plurality of LED lamps may be selectively oriented on the substrate at least during fabrication thereof, so as to shape output light beam.

2. The apparatus of claim 1, wherein an LED lamp generates a cone shaped light pattern ranging between 6 and 30°.

3. The apparatus of claim 1, wherein the LED lamp generates an optimum 8° cone shaped light pattern.

4. The emitted cone shaped light pattern of claim 2, comprising a 1 inch (2.5 cm) long light pattern.

5. The emitted cone shaped light pattern of claim 2, wherein each light pattern overlaps at a distance greater than 1 inch (2.5 cm).

6. The apparatus claim 1, wherein the substrate comprises a hot resin formation or cold resin formation.

7. The apparatus of claim 1, wherein the plurality of LED lamps sit generally perpendicular to a planar surface the substrate.

8. The apparatus of claim 1, wherein the substrate is affixed to the traffic signal housing by welding, stapling, glue, or fasteners.

9. A light head for a traffic signal housing, comprising:
a mounting structure for coupling a traffic signal housing; and
a plurality of LED lamps selectively oriented obliquely at least relative to each other in the mounting structure so that respective projected outputs thereof are combined and shaped to form a selected pattern including at least one of desired intensity and direction.

10. The apparatus of claim 9, wherein an LED lamp generates a cone shaped light pattern ranging between 6 and 30°.

11. The apparatus of claim 9, wherein the LED lamp generates an optimum 8° cone shaped light pattern.

12. The emitted cone shaped light pattern of claim 10, comprising a 1 inch (2.5 cm) long light pattern.

13. The emitted cone shaped light pattern of claim 10, wherein each light pattern overlaps at a distance greater than 1 inch (2.5 cm).

14. The apparatus claim 9, wherein the mounting structure comprises at least one printed circuit board, at least one wing plate, and at least one vertical plate.

15. The apparatus of claim 9, wherein the plurality of LED lamps sit generally perpendicular to a planar surface in the at least one printed circuit board.

16. The apparatus of claim 9, wherein the at least one printed circuit board is affixed to the wing plate by welding, stapling, glue, or fasteners.

17. The apparatus of claim 14, wherein the at least one printed circuit board is angled generally downward by the at least one vertical plate from a back surface of the signal housing.

18. The apparatus claim 14, wherein the at least one wing plate orients the at least one printed circuit board inward from a center line of the at least one vertical plate.

19. The apparatus of claim 14, wherein the at least one vertical plate is affixed to the at least one wing plate and a back surface of the signal housing by welding, stapling, glue, or fasteners.

20. A method of shaping a desired beam path of light, method comprising:
coupling a mounting assembly to a signal housing;
orienting a plurality of LED lamps coupled to the mounting assembly within the signal housing; and
transmitting a signal from the signal housing to a street using a traffic signal device.

21. The method of claim 20 wherein an LED lamp generates a cones shaped light pattern ranging between 6 and 30°.

22. The method of claim 20, wherein the LED lamp generates an optimum 8° cone shaped light pattern.

23. The method of claim 21, wherein the emitted cone shaped light pattern comprises a 1 inch (2.5 cm) long light pattern.

24. The method of claim 21, wherein the emitted cone shaped light pattern overlaps at a distance greater than 1 inch (2.5 cm).

25. The method of claim 20, wherein the mounting surface assembly comprises at least one printed circuit board, at least one wing plate, and at least one vertical plate.

26. The method of claim 20, wherein the plurality of LED lamps are arrayed on the at least one printed circuit board equidistant between other.

27. The method of claim 20, wherein the plurality of LED lamps sit generally perpendicular to a planar surface of the at least one printed circuit board.

28. The method of claim 25, wherein the printed circuit board is mounted generally flat onto the wing plate.

29. The method of claim 25, wherein the at least one printed circuit board is angled downward 4.6° by the at least one vertical plate from a back surface of a signal housing.

30. The method of claim 25, wherein the wing plate positions the printed circuit board inward by an angle of 3.5° from a center line of the at least one vertical plate.

31. The method of claim 25, wherein the at least one vertical plate is affixed to the at least one wing plate and a back surface of the signal housing by welding, stapling, fasteners, or glue.

32. A mounting plate assembly for a light head of a traffic signal housing, comprising:
at least one printed circuit board, at least one wing plate, and at least one vertical plate coupled to a signal housing.

33. The apparatus of claim 32, wherein the at least one printed circuit board is affixed to the wing plate by welding, stapling, glue, or fasteners.

34. The apparatus of claim 32, wherein the printed circuit board is angled generally downward by the at least one vertical plate from a back surface of the signal housing.

35. The apparatus of claim 32, wherein the at least one wing plate orients the at least one printed circuit board inward from a center line of the at least one vertical plate.

36. The apparatus of claim 32, wherein the at least one vertical plate is affixed to the at least one wing plate and a back surface of the signal housing by welding, stapling, glue, or fasteners.
